(19) United States
(12) Patent Application Publication
(10) Pub. No.: US 2008/0199066 A1
(43) Pub. Date: Aug. 21, 2008

(54) Sample image obtaining method, sample image obtaining apparatus and sample image filing system

(75) Inventors: Takuma Watanabe, Nishinomiya-shi (JP); Youichi Sumida, Kobe-shi (JP)

Correspondence Address: BRINKS HOFER GILSON & LIONE, P.O. BOX 10395, CHICAGO, IL, 60610, US

(73) Assignee: Sysmex Corporation

(21) Appl. No.: 11/998,076

(22) Filed: Nov. 28, 2007

(30) Foreign Application Priority Data
Dec. 1, 2006 (JP) 2006-325497

(51) Int. Cl. G06K 9/00

(52) U.S. Cl. 382/133

(57) ABSTRACT

The present invention is to present a sample image obtaining method that is capable of reflecting the blood cell concentration of a sample and increasing the speed of the examination. The sample image obtaining method comprises steps of: (a) obtaining a wide area image of a sample by imaging, at a predetermined magnification, a wide area including a smearing end of a smear region on a slide glass where the sample is smeared; (b) detecting the smearing end based on luminance information of the wide area image of the sample; (c) determining an imaging region in the smear region based on the detected smearing end; and (d) obtaining a sample image by imaging the determined imaging region at a higher magnification than the predetermined magnification.

### RELATED APPLICATIONS

This application claims priority under 35 U.S.C. §119 to Japanese Patent Application No. JP2006-325497 filed Dec. 1, 2006, the entire content of which is hereby incorporated by reference.

### FIELD OF THE INVENTION

The present invention relates to a sample image obtaining method, sample image obtaining apparatus, and sample image filing system. More specifically, the present invention relates to a method and apparatus for obtaining a sample image obtained by imaging a smear slide prepared by smearing a sample on a slide glass, and a system for filing the obtained sample images.

### BACKGROUND

A method called “microscopic examination” is conventionally used to examine blood cells, and in this method, blood thinly smeared on a slide is visually inspected using a microscope.

It is generally difficult to prepare a smear slide which has a uniform blood cell distribution because the condition of the blood cells and the densities of the blood cell distributions on the slide are different according to the blood smear condition. In blood examinations, therefore, the laboratory technician looks thorough a microscope and looks for an area where blood cells are uniformly distributed in order to classify the blood cells for each sample.

However, the method that the technician searches for a suitable examination area for each sample is inefficient and an obstacle for laborsaving and high-speed examination.

Therefore, for example, U.S. Pat. No. 4,362,386 discloses an apparatus which is capable of automatically determining suitable observation positions on a sample. The apparatus is capable of selecting an optimum observation position in the longitudinal direction of a slide by measuring the density of blood cells in the longitudinal direction while moving the semiconductor linear blood cell detector in the longitudinal direction of the slide, and by comparing the measurement result to a preset red blood cell density range.

On the other hand, in the previously mentioned microscopic examination method, the technician must perform the examination at the location where the microscope is positioned, which inconveniently restricts the examination location.

To eliminate this inconvenience, U.S. Patent Publication No. 2006-050948 discloses an examination method which obtains an electronic image (virtual slide) of a wide range of a smear slide, and performs an examination using the obtained electronic image.

However, in the method disclosed in U.S. Pat. No. 4,362,386, regardless of the fact that the blood cell concentration (density) in the blood differs according to the sample, a region of a predetermined blood cell concentration is detected in the cases of high concentration blood and low concentration blood. Therefore, an image which reflects the blood cell concentration can not be obtained. Furthermore, the semiconductor linear blood cell detector must move along the longitudinal direction of the slide to detect the change of blood cell density in the longitudinal direction. Accordingly, there is a limit to the high-speed examination.

Moreover, the method disclosed in U.S. Patent Publication No. 2006-050948 obtains the electronic image of a wide region of the smear slide and does not capture only a suitable region of a sample.

### SUMMARY

A first aspect of the present invention is a sample image obtaining method, comprising steps of: (a) obtaining a wide area image of a sample by imaging, at a predetermined magnification, a wide area including a smearing end of a smear region on a slide glass where the sample is smeared; (b) detecting the smearing end based on luminance information of the wide area image of the sample; (c) determining an imaging region in the smear region based on the detected smearing end; and (d) obtaining a sample image by imaging the determined imaging region at a higher magnification than the predetermined magnification.

A second aspect of the present invention is a sample image obtaining apparatus, comprising: a first image obtaining section for obtaining a wide area image of a sample obtained by imaging, at a predetermined magnification, a wide area including a smearing end of a smear region on a slide glass where the sample is smeared; detecting means for detecting the smearing end based on luminance information of the wide area image of the sample; determining means for determining an imaging region in the smear region based on the detected smearing end; and a second image obtaining section for obtaining a sample image obtained by imaging the determined imaging region at a higher magnification than the predetermined magnification.

A third aspect of the present invention is a sample image filing system, comprising: the sample image obtaining apparatus of claim 9; and a sample image managing apparatus being connected to the sample image obtaining apparatus over a network and managing the sample image transmitted from the sample image obtaining apparatus, wherein the sample image obtaining apparatus comprises image transmitting means for transmitting the sample image to the sample image managing apparatus; and wherein the sample image managing apparatus comprises: image receiving means for receiving the sample image transmitted by the image transmitting means over the network; and a memory for storing the sample image with identification information of the sample.

### BRIEF DESCRIPTION OF THE DRAWINGS

FIG. 1 shows the overall structure of a network system in which the data of images obtained by the sample image obtaining apparatus of an embodiment of the present invention are sent to a client terminal;

FIG. 2 shows the overall structure of the sample image obtaining apparatus of an embodiment of the present invention;

FIG. 3 shows the processing target region in a wide area sample image;

FIG. 4 illustrates an example of a method for determining a threshold value in the sample image obtaining method of the present invention;

FIG. 5 illustrates another example of a method for determining a threshold value;

FIG. 6 illustrates still another example of a method for determining a threshold value;

FIG. 7 illustrates an example of a method for determining a boundary position in the sample image obtaining method of the present invention;

FIG. 8 shows the boundary between a smear region and a non-smear region;

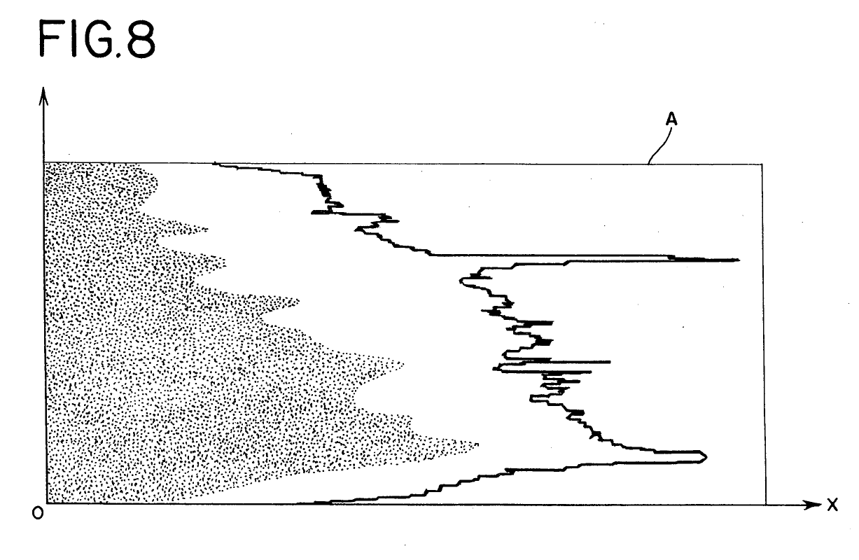

FIG. 9 shows the imaging region set within the smear region;

FIG. 10 is a flow chart of the sample image obtaining method of an embodiment of the present invention;

FIG. 11 is a flow chart of the sample image obtaining method of an embodiment of the present invention; and

FIG. 12 is a flow chart of the sample image obtaining method of an embodiment of the present invention;

### DETAILED DESCRIPTION OF THE EMBODIMENT

The embodiments of the sample image obtaining method and apparatus of the present invention are described in detail hereinafter with reference to the accompanying drawings.

The image obtained by the sample image obtaining apparatus S of the embodiment of the present invention is a blood cell image (virtual slide, hereinafter also referred to as “VS”).

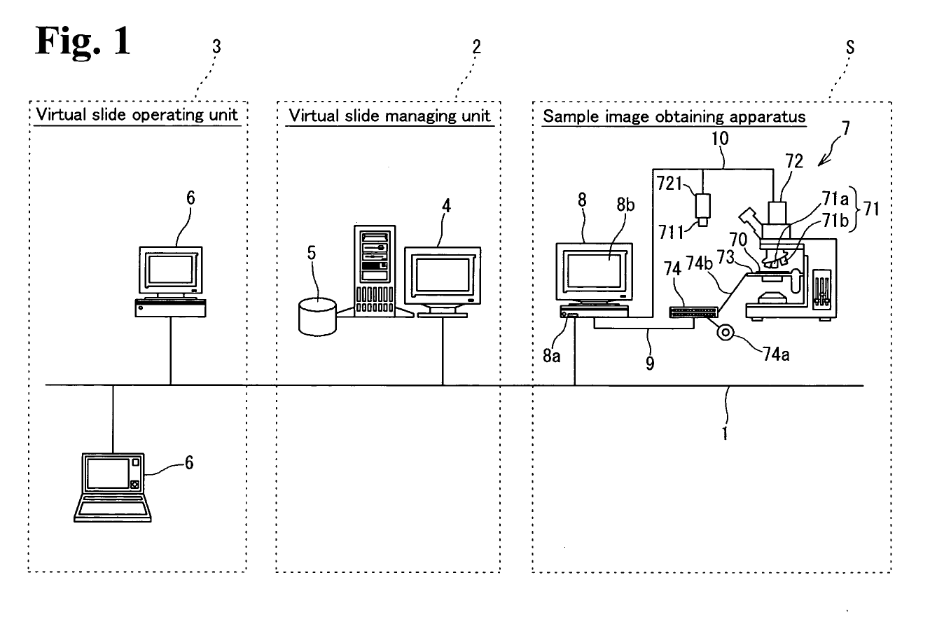

A sample image obtaining apparatus S is connected to a virtual slide managing unit 2 and virtual slide operating unit 3 through a LAN cable 1 used as a network cable, as shown in FIG. 1. A server 4, which stores virtual slide data and manages the virtual slide data, is provided in the virtual slide managing unit 2. The server 4 is provided with a database 5, which stores tables for the identification information and attribute information. The virtual slide data are stored in the database 5 together with identification information such as sample number and the like. Attribute information includes patient attribute information such as patient number, patient name, sex, age, blood type, ward, diagnostic materials, name of disease, medical records, attending physician, impressions/findings and the like, as well as sample attribute information such as blood examination date, request number, date the sample was collected, sample type, sample comments and the like. The virtual slide operating unit 3 is provided with a client terminal 6 for evaluating and confirming virtual slides.

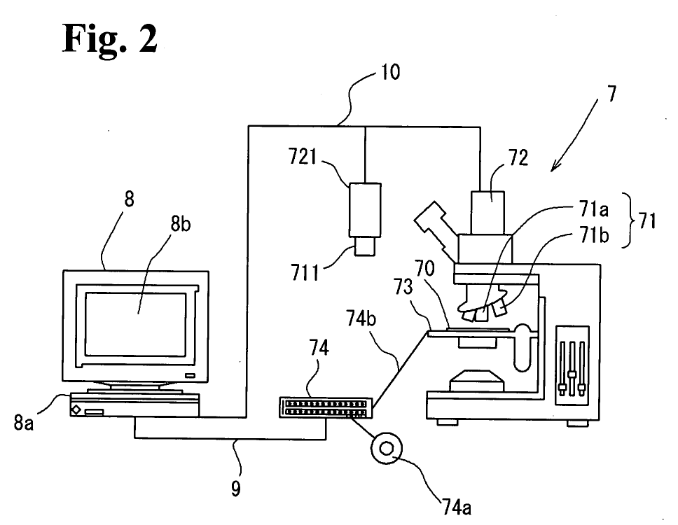

The sample image obtaining apparatus S is also provided with an optical microscope 7 and terminal 8, as shown in FIG. 2. An Olympus BX-series microscope (Olympus Corporation), for example, may be used as the optical microscope 7.

The optical microscope 7 is mainly configured by an objective lens 71, 3CCD camera 72, macro lens 711, macro image capturing camera 721, automatic stage 73, and control unit 74. The objective lens 71 is provided to obtain an enlarged image of blood cells smeared on a slide 70. The objective lens 71 includes a 20× objective lens 71a, and 100× objective lens 71b. The macro lens 711 is provided to obtain a wide area sample image.

The macro image capturing camera 721 is provided to obtain a wide area sample image through the macro lens 711. A Sony model DFW-SX910 (Sony Corporation), for example, may be used as the micro image capturing camera.

The 3CCD camera 72 is provided to obtain an enlarged image of blood cells smeared on the slide 70 through the objective lens 71. The Hitachi HV-F22CL series (Hitachi International Electronics Corporation), for example, may be used as the 3CCD camera.

The automatic stage 73 of the optical microscope 7 is configured to retain the slide 70 which has the smeared blood cells, and move in three directions, that is, the X-axis direction, Y-axis direction, and Z-axis direction. The X-axis direction is a predetermined direction parallel to the surface of the automatic stage 73 which retains the slide 70, the Y-axis direction is a direction parallel to the automatic stage 73 and perpendicular to the X-axis direction. The Z-axis direction (refer to FIG. 2) is a direction perpendicular to the surface of the automatic stage 73.

In the present embodiment, the focus position of the objective lens 71 on blood cells can be changed in the depth direction (Z-axis direction) in the same field of view by moving the automatic stage 73 that retains a slide 70 having the smeared blood cells in the Z-axis direction. Furthermore, the planar field of view of the objective lens 71 relative to the blood cells can be changed by moving the automatic stage 73 that retains a slide 70 having the smeared blood cells in the X-axis direction or Y-axis direction.

The control unit 74 of the optical microscope 7 is provided to perform positional control (adjustment) of the automatic stage 73. The control unit 74, a positional adjustment means, includes a joystick 74a and is connected to the automatic stage 73 through a cable 74b. The automatic stage 73 can be moved in the X-axis direction, Y-axis direction, and Z-axis direction by operating the joystick 74a.

The terminal 8 of the sample image obtaining apparatus S is connected to the control unit 74 through a cable 9, and connected to the 3CCD camera 72 through a cable 10. Thus, controls signals to control the control unit 74 are sent from the terminal 8 to the control unit 74 through the cable 9. Furthermore, the image data obtained by the 3CCD camera 72 are sent to the terminal 8 through the cable 10. The terminal 8 has a memory means (not shown in the drawings) to store the received image data and the like, a control device 8a which includes a controller configured by a CPU and the like, and a display unit 8b to display the images.

A characteristic feature of the present embodiment is that the boundary (smear edge) between a smear region and non-smear region is set on the downstream side in the direction of the blood smear, based on luminance information of the wide area sample image obtained by imaging at a predetermined magnification (for example, approximately 5× to 6×), and an imaging region within the smear region is determined based on this boundary. The method for determining the imaging region is described below.

First, a smear slide prepared by smearing blood to be examined on the surface thereof is retained on the automatic stage 73 of the optical microscope 7. Then, the macro lens 711, which has a magnification of 5× to 6×, is positioned above the smear slide. The focus position of the optical system which includes the macro lens 711 is then focused on the smear slide by operating the joystick 74a. The position of the automatic stage 73 is also adjusted in the X-axis direction and Y-axis direction so that a wide area which includes at least the boundary between the smear region in which the blood is smeared and the non-smear region in which the blood is not smeared is included in the imaging region of the 3CCD camera 72.

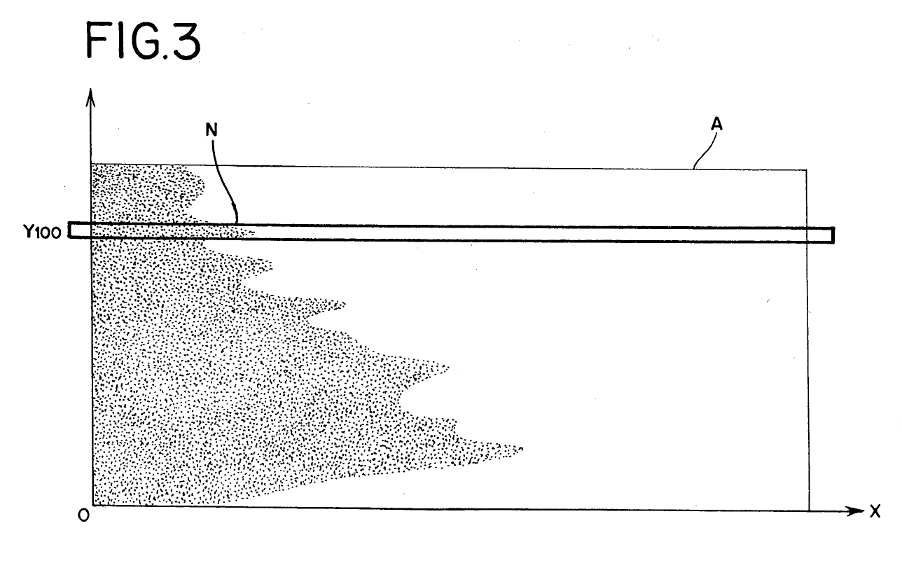

Next, the wide area region is imaged by the macro image capturing camera 721 to obtain a wide area sample image. The wide area sample image normally includes the non-smear region on the upstream side (opposite side to the smear direction) from the blood smear starting position and the non-smear region near both ends in the width direction of the slide, that is, the image includes areas that are not required for the imaging region determining process and boundary determining process in the present embodiment. As shown in FIG. 3, the blood smear starts at the left end (left end in FIG. 3; henceforth the same), and the blood smear ends at the right end, that is, a rectangular processing target region A is set that has the smallest non-smear area possible at top and bottom ends. In the processing target region A, the bottom left corner is set as the origin point, and the X coordinates are set in the rightward direction (smear direction), and the Y coordinates are set in the upward direction. The coordinates can be set to correspond to pixels, which are the image units of the wide area sample image.

The image of the processing target region A is gray-scaled to obtain an achromatic image. Since the image of the processing target region A includes noise N caused by bubbles, pieces of bone, dust and the like, the noise is eliminated from the image of the processing target region A by a method described later (the method creates a luminance group every time a luminance exceeds threshold value, and assigns ID to the group).

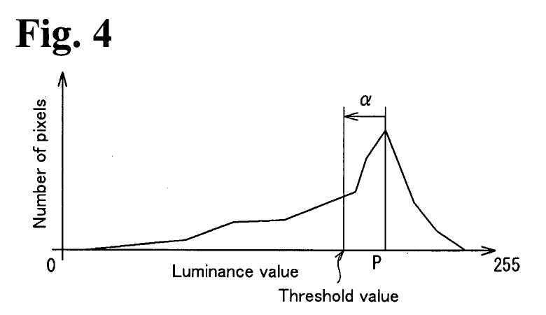

Next, a histogram is prepared from image color information (for example, a luminance value) at each Y coordinate (Y₁ to Yₙ), such as the one shown in FIG. 4. Specifically, a histogram is prepared from, for example, luminance values at all points (X₁ to Xₘ) that have Y₁₀₀ as Y coordinate (this luminance value is calculated from the RGB value of individual pixels, which are set at values in a range from 0 to 255). In the area in which a lot of blood is smeared, such as near the blood smear starting position, the luminance values are the smallest since the image becomes darker mainly due to the influence of red blood cells. In the imaged area in which the surface of the slide glass does not have any blood smear, the image is brighter and the luminance values are high values.

The luminance value prevalent to the most pixels is determined from the histogram. In FIG. 4, the luminance value indicated by P is such a value. The present inventors acquired wide area sample images and investigated various types of histograms prepared from these wide area sample images, and discovered that luminance values of the peak parts of the histogram (the luminance values prevalent to the most pixels) correspond to luminance values of the glass surface of the slide. In a smear slide, the amount of blood distributed gradually decreases from where the blood smear starts to where the smear ends, and the luminance values increase accordingly. Therefore, a luminance value somewhat lower than the luminance value of the peak part is set as the threshold value. Specifically, in FIG. 4 for example, the luminance value is calculated as α=15.

When the amount of blood smear decreases completely in a gradual manner from the start of the blood smear to the end of the smear, the boundary line between the smear region and the non-smear region can be prepared by setting the value of the X coordinate (which exists in several adjacent points) representing the threshold value as the boundary coordinate, and connecting this boundary coordinate through Y₁ to Yₙ. However, it is unlikely in actual fact to decrease the amount of the blood distribution completely in a gradual manner, and a large amount of noise which can not be eliminated by the process described above will be present.

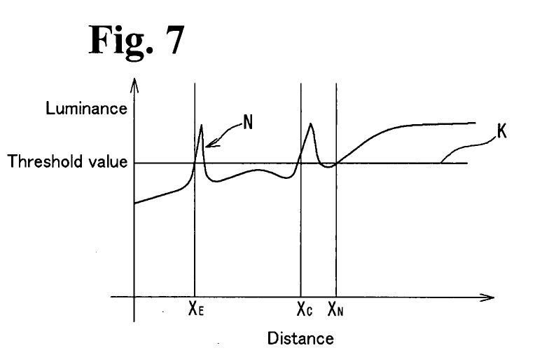

As shown in FIG. 7, the influence of a large part of the noise can be eliminated so as to essentially determine a boundary position in the present embodiment.

FIG. 7 shows the change in luminance in the smear direction of a certain Y coordinate value (for example, Y₁₀₀), and the vertical axis represents the value of luminance. The horizontal axis represents the distance from the origin in the smear direction in the processing target region, and corresponds to the X coordinates in FIG. 3. K represents the threshold value calculated by the previously described method.

In the example of FIG. 7, noise is present in the area indicated by N. Therefore, when the X coordinate value (X_{E}) is determined for the boundary coordinate between the background image (non-smear region) and the blood image (smear region) upon close examination of the luminance of the processing target image from the left (smear starting side), an X coordinate value (X_{E}) which is less than the proper boundary position (indicated by Xc in FIG. 7) may be set as the boundary position.

Such an erroneous determination can be avoided in the manner described below. As an example, a luminance group is created every time a value of luminance exceeds the threshold value (every time the luminance curve represented in the histogram of FIG. 7 intersects the threshold line from bottom to top), and an ID is allocated to this group. Then, the numbers of pixels are counted for each luminance group, and an initial boundary position (provisional boundary position) is set. In FIG. 7, X_{E} is the X coordinate value at which the luminance curve initially intersects the threshold line, and this value X_{E} is set as the initial boundary position (provisional boundary position).

With regard to the group from the initial boundary position to the next intersection point (X_{C} in FIG. 7), the number of pixels having a luminance above the threshold value and the number of pixels having a luminance below the threshold value are compared, and the boundary position is moved if and the number of pixels with a luminance below the threshold value is higher, and X_{C} is set as the new boundary position.

Similarly, the number of pixels having a luminance above the threshold value and the number of pixels having a luminance below the threshold value are compared for the group from the new boundary position to the next intersection point (X_{N} in FIG. 7). Then, although the boundary position is moved if the pixels having a luminance below the threshold value are more numerous, in the present example the boundary position is unchanged since the pixels having a luminance above the threshold value are more numerous.

The effects of noise are eliminated by performing this process and a boundary position can be calculated.

Thus, the boundary line between the smear region and the non-smear region can be determined by performing the above described process on all Y coordinate values (Y₁ to Yₙ) of the processing target region and connecting the obtained boundary positions (represented by X coordinate values).

Next, a sample image is obtained by setting an imaging region within the smear region based on the boundary and imaging this imaging region at a magnification which is higher (for example, 20× to 100×) than the magnification used when imaging the wide area sample image (which was for example, 5× to 6×).

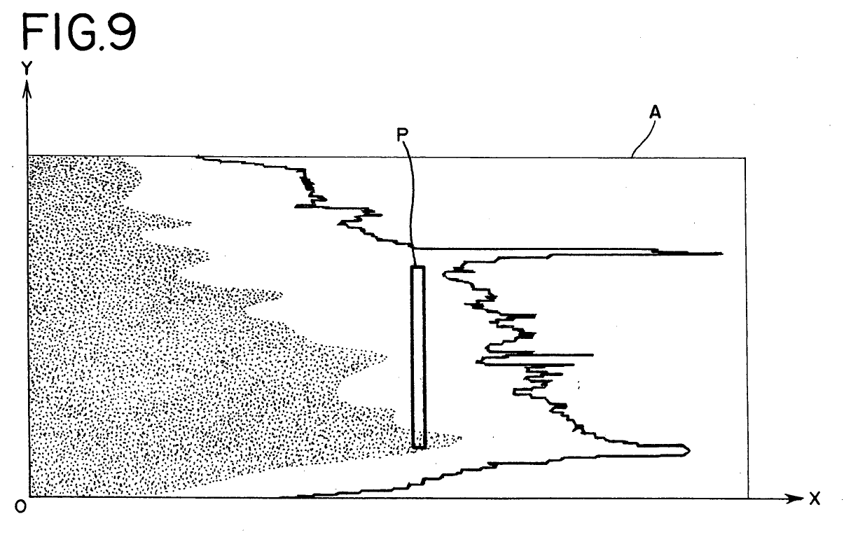

FIG. 9 shows the imaging region set within the smear region; a rectangular imaging region of approximately 6 mm² is set in the example. The imaging region P is within the smear region on the left side of the boundary, that is, the imaging region P is set at a position unconnected to the boundary near the top end and bottom end in FIG. 9. The imaging region P is set at a position adjacent to the boundary in a region which satisfies the above-mentioned conditions.

In a smear slide, the amount of blood distributed gradually decreases from where the blood smear starts to where the smear ends, and the blood cell concentration on the slide also gradually decreases accordingly. Although it is desirable that the red blood cells are mutually dispersed at suitable intervals on the smear slide (the majority of the blood cells are red blood cells) in order to classify the blood cells, the red blood cells actually over lay one another and are mutually adjacent in state of high concentration distribution from the start of the smear to the vicinity of half way in the smear region on the smear slide. On the other hand, a region with suitable blood cell concentration in which the blood cells do not overlay one another is present from the half way point to the end of the smear region. Therefore, blood cells can be accurately classified by setting this region as the examination region.

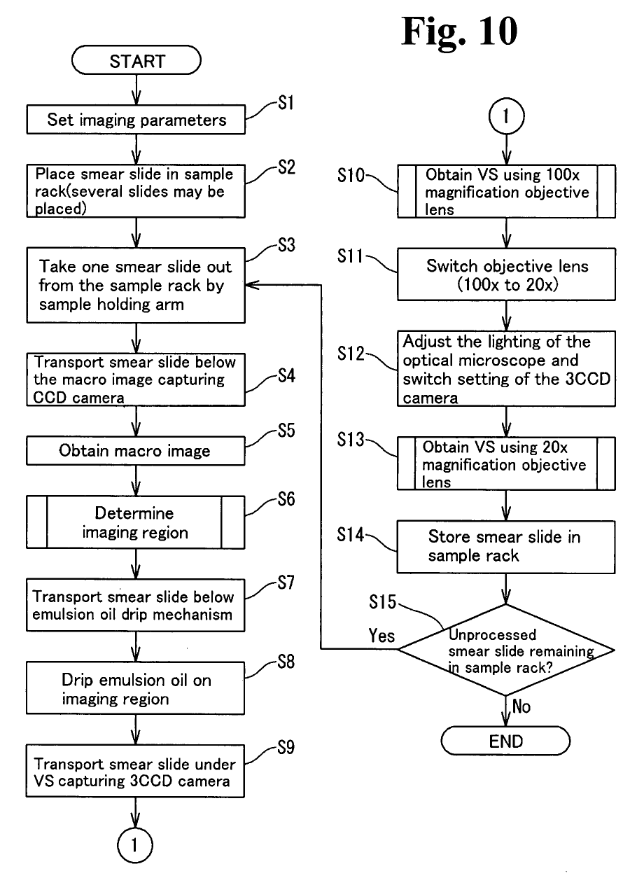

The entire flow of the sample image obtaining method of the present embodiment is described below with reference to the flow charts of FIGS. 10 through 12.

First, the imaging parameters are set (step S1). Imaging parameters include, for example, the number of images in the Z-axis direction, stepping width in the Z-axis direction, 3CCD camera settings (RGB values, gamma value, shutter speed and the like). These imaging parameters are determined for the 20× objective lens 71a and 100× objective lens 71b, respectively.

Then, a smear slide is placed in a sample rack (not shown in the drawing) (step S2). A plurality of smear slides may also be placed in the sample rack. Next, one smear slide is taken out from the sample rack by a sample holding arm (not shown in the drawing) (step S3), and the taken out smear slide is transported below the micro image capturing camera 721 (step S4).

A macro image of the smear slide is obtained thereafter (step S5). An imaging region is then determined based on the obtained macro image (step S6).

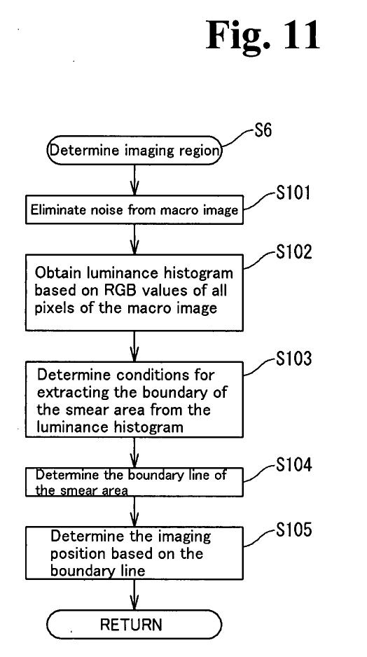

The imaging region is determined as follows. As shown in FIG. 11, noise is first eliminated from the macro image (step S101), then a luminance histogram is obtained based on the RGB values of all pixels of the macro image (step S102). The parameters are determined for extracting the boundary between the smear area and the non-smear area from the obtained histogram (step S103), and then the boundary between the smear area and the non-smear area is determined based on the set parameters (S104). Thereafter, the imaging positions for the 20× magnification objective lens 71a and 100× magnification objective lens 71b are respectively determined based on the determined boundary (step S105).

After the imaging region has been set in step S6, the smear slide is transported below an emulsion oil drip mechanism not shown in the drawing (step S7), and an emulsion oil is dripped onto the determined imaging region (step S8).

Then, the smear slide is transported below the VS capturing 3CCD camera 72 (step S9), and a VS is prepared by the 100× objective lens 71b (step S10). Then, the objective lens is switched from 100× magnification to 20× magnification (step S11). The lighting of the optical microscope 7 is adjusted and the settings of the 3CCD camera 72 are switched (step S12), then a VS is obtained by the 20× magnification objective lens 71a (step S13). The image obtained using the 20× magnification objective lens also may be taken before the image obtained using the 100× magnification objective lens.

The VS images are obtained as follows in steps S10 and S13.

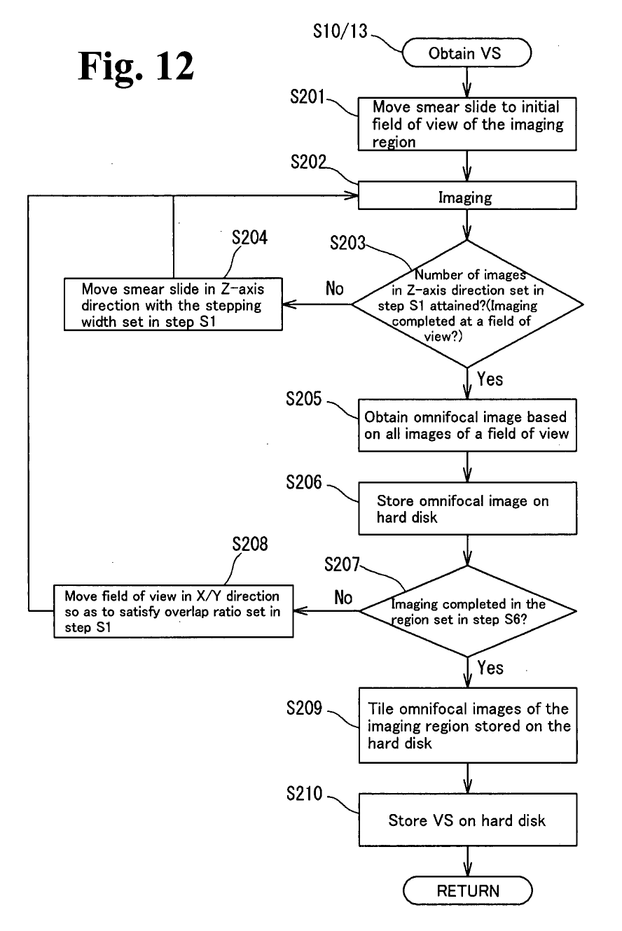

As shown in FIG. 12, the smear slide is moved to the initial field of view of the imaging region determined in step S6 (step S201), and the sample is imaged (step S202). Next, a determination is made as to whether or not the number of images in the Z-axis direction set in step S1 has been attained, that is, whether or not the imaging of a field of view is completed (step S203). When imaging at a field of view has not been completed, the smear slide is moved in the Z-axis direction with the stepping width set in step S1 (step S204), the routine returns to step S202 and the smear slide is imaged. When it is determined that the set number of images in the Z-axis direction have been attained, an omnifocal image (an image which is entirely focused by combining several images having different focused parts) is obtained based on the all images of a field of view (step S205).

The obtained omnifocal image is then stored on the hard disk (memory means) (step S206). Next, a determination is made as to whether or not imaging of the region set in step S6 is complete (step S207); when incomplete, the field of view is moved in the X/Y direction so as to satisfy the overlap ratio set in step S1 (step S208), the routine returns to step S202 and the smear slide is imaged.

On the other hand, when it is determined that imaging in the region set in step S6 has been completed, the omnifocal images stored on the hard disk are tiled (step S209), and the VS is stored on the hard disk (step S210).

After the VS has been obtained by the 20× magnification objective lens and the 100× magnification objective lens, the smear slide used in the imaging is stored in the sample rack (step S14). The sample rack in which the smear slide is stored after imaging may be the same rack in which the smear slide was stored before imaging (refer to FIG. 2), or may be a different sample rack.

Then a determination is made as to whether or not any unprocessed smear slides remain in the sample rack (sample rack of step S2); when a smear slide remains, the next smear slide is taken from the sample rack by the sample holding arm, and the each of the processes of steps S5 through S14 are repeated. However, imaging ends when no unprocessed smear slide remains in the sample rack.

In the embodiment described above, the end of the smear is detected automatically from the luminance information of the wide area image of the sample obtained at low magnification, and the imaging region set based on the end of the smear is imaged at high magnification. Therefore, a region suited for imaging can be automatically selected quickly and a needed sample image can be obtained. Accordingly, the labor of examination is thus streamlined and examination itself is accelerated.

Furthermore, blood cells can be accurately classified by setting an image region P in the vicinity of the boundary in which the blood is thinly and uniformly distributed (blood cells including red blood cells are uniformly distributed without being mutually overlaid or adjacent), and setting this region as the examination region.

Although blood cells are the object of examination in the present embodiment, the present invention is not limited to blood cells inasmuch as biological tissue and tangible urine components may also be objects of examination in addition to blood cells.

Although a macro image capturing camera 721 is provided to obtain a wide area sample image, and a 3CCD camera 72 is provided to obtain an enlarged image of blood cells smeared on the slide 70 in the present embodiment, the present invention is not limited to this configuration inasmuch as a single camera may be used to obtain both the wide area sample image and the enlarged image of the blood cells.

Although the luminance value shared by the most pixels is determined and a luminance value smaller than this luminance value by a predetermined value is set as the threshold in the present embodiment, the threshold value may also be determined by other methods.

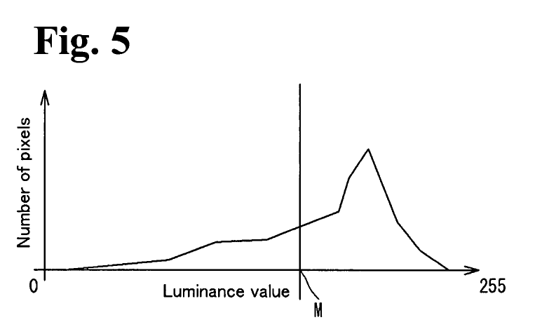

For example, although the sequence of obtaining the histogram is like the one above, the number of pixels may be added from the origin point in the histogram and a luminance value M at a position half way to the total number of images may be set as the threshold value (refer to FIG. 5).

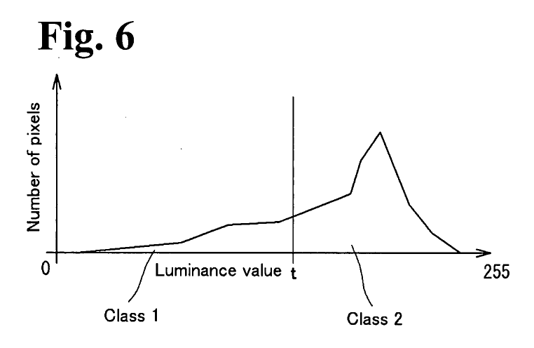

Furthermore, when a histogram obtained by the same method is divided into two groups by a certain value t, the value t which has the greatest dispersion between the groups may be set as the threshold value (refer to FIG. 6). Specifically, the interclass dispersion σ_{B}²(t) and intraclass dispersion σ₁²(t) can be determined by equations (1) and (2) below when an image has a luminance range of 0 to 255 is binarized by t, and the average luminance of pixels [0 to t−1] is set as fo, the average luminance of pixels [0 to 255] at fl, the average luminance of all pixels is set as f, and the number of pixels which have a luminance k is set as nₖ.

$$\begin{matrix}[ Eq . 1 ] & \\ {σ}_{B}^{2} ( t ) = \frac{{\sum }_{K = 0}^{t - 1} {{n}_{k} ( {\overline{f}}_{0} - f )}^{2} + {\sum }_{K = t}^{D} {{n}_{k} ( {\overline{f}}_{1} - \overline{f} )}^{2}}{{\sum }_{K = 0}^{D} {n}_{k}} & ( 1 ) \\ [ Eq . 2 ] & \\ {σ}_{I}^{2} ( t ) = \frac{{\sum }_{K = 0}^{t - 1} {{n}_{k} ( k - {\overline{f}}_{0} )}^{2} + {\sum }_{K = t}^{D} {{n}_{k} ( k - {\overline{f}}_{1} )}^{2}}{{\sum }_{K = 0}^{D} {n}_{k}} & ( 2 )\end{matrix}$$

The dispersion ratio Fo(t) at this time is expressed by equation (3) below, and a value t is set as the threshold when this dispersion ratio Fo(t) is maximum.

$$\begin{matrix}[ Eq . 3 ] & \\ {F}_{0} ( t ) = \frac{{σ}_{B}^{2}}{{σ}_{I}^{2}} & ( 3 )\end{matrix}$$

What is claimed is:

1. A sample image obtaining method, comprising steps of:
(a) obtaining a wide area image of a sample by imaging, at a predetermined magnification, a wide area including a smearing end of a smear region on a slide glass where the sample is smeared;
(b) detecting the smearing end based on luminance information of the wide area image of the sample;
(c) determining an imaging region in the smear region based on the detected smearing end; and
(d) obtaining a sample image by imaging the determined imaging region at a higher magnification than the predetermined magnification.

2. The sample image obtaining method of claim 1, wherein
the step (c) comprises a step of determining the imaging region near the smearing end.

3. The sample image obtaining method of claim 1, wherein
the step (b) comprises a step of generating luminance frequency information from each luminance of a plurality of pixels configuring the wide area image of the sample and detecting the smearing end based on the luminance frequency information.

4. The sample image obtaining method of claim 3, wherein
the step (b) comprises a step of detecting one or plurality of provisional smearing ends based on the luminance frequency information and determining one among the detected provisional smearing ends as the smearing end.

5. The sample image obtaining method of claim 1, wherein
the wide area is an area including a whole of the smear region.

6. The sample image obtaining method of claim 1, further comprising
a step of displaying the sample image.

7. The sample image obtaining method of claim 1, further comprising
a step of adjusting a position of the slide glass based on the determined imaging region before executing the step (d).

8. The sample image obtaining method of claim 1, wherein the sample is blood.

9. A sample image obtaining apparatus, comprising:
a first image obtaining section for obtaining a wide area image of a sample obtained by imaging, at a predetermined magnification, a wide area including a smearing end of a smear region on a slide glass where the sample is smeared;
detecting means for detecting the smearing end based on luminance information of the wide area image of the sample;
determining means for determining an imaging region in the smear region based on the detected smearing end; and
a second image obtaining section for obtaining a sample image obtained by imaging the determined imaging region at a higher magnification than the predetermined magnification.

10. The sample image obtaining apparatus of claim 9, wherein
the determining means determines the imaging region near the smearing end.

11. The sample image obtaining apparatus of claim 9, wherein
the detecting means generates luminance frequency information from each luminance of a plurality of pixels configuring the wide area image of the sample and detecting the smearing end based on the luminance frequency information.

12. The sample image obtaining apparatus of claim 11, wherein
the detecting means detects one or plurality of provisional smearing ends based on the luminance frequency information and determines one among the detected provisional smearing ends as the smearing end.

13. The sample image obtaining apparatus of claim 9, wherein the wide area is an area including a whole of the smear region.

14. The sample image obtaining apparatus of claim 9, further comprising:
an imaging section for imaging the imaging region at the higher magnification; and
position adjusting means for adjusting a relative position between the imaging section and the sample smeared on the slide glass based on the determined imaging region.

15. The sample image obtaining apparatus of claim 9, further comprising
a display section for displaying the sample image.

16. The sample image obtaining apparatus of claim 9, wherein the second image obtaining section further obtains a second sample image obtained by imaging the determined imaging region at a second magnification higher than the magnification used for obtaining the sample image.

17. The sample image obtaining apparatus of claim 9, wherein the sample is blood.

18. A sample image filing system, comprising:
the sample image obtaining apparatus of claim 9; and
a sample image managing apparatus being connected to the sample image obtaining apparatus over a network and managing the sample image transmitted from the sample image obtaining apparatus,
wherein
the sample image obtaining apparatus comprises image transmitting means for transmitting the sample image to the sample image managing apparatus;
and wherein
the sample image managing apparatus comprises:
image receiving means for receiving the sample image transmitted by the image transmitting means over the network; and
a memory for storing the sample image with identification information of the sample.

19. The sample image filing system of claim 18, wherein
the sample image obtaining apparatus comprises a display section for displaying the sample image.

20. The sample image filing system of claim 18, further comprising
a client device connected to the sample image managing apparatus over the network,
wherein
the client device comprises a display section for displaying the sample image stored in the memory.
